(19) United States
(12) Patent Application Publication
(10) Pub. No.: US 2017/0083926 A1
(43) Pub. Date: Mar. 23, 2017

(54) VISUALIZING AND CORRELATING FEEDBACK INFLUENCERS

(71) Applicant: HomeAway, Inc., Austin, TX (US)

(72) Inventors: Chris Karcher, Cedar Park, TX (US); Michael Conley, Austin, TX (US)

(21) Appl. No.: 14/862,126

(22) Filed: Sep. 22, 2015

(51) Int. Cl. G06Q 30/02; G06F 17/30

(52) U.S. Cl. CPC G06Q 30/0201; G06F 17/3053

(57) ABSTRACT

Various embodiments relate generally to a system, a device and a method provide for detecting influencer events based on received feedback data. A request may be received to predict an event for received feedback data from a plurality of customer computing devices communicatively coupled, through a network, with a web service application. A plurality of disparate data sources may provide data points from different applications and/or databases through application programming interfaces. The data points for a time period corresponding to the received feedback data may be retrieved to identify candidate events. The feedback data may be characterized and used to determine one or more ranked predictions using a heuristics engine. The heuristics engine may process the data points and the received characterized feedback data to rank predictions that influenced the feedback data. The data may also be visualized and interacted with by users of the listing management system.

### FIELD

Various embodiments relate generally to electrical and electronic hardware, computer software, wired and wireless network communications, and distributed software applications for receiving and processing feedback from users. More specifically, a system and a method provide for visualizing and/or correlating user feedback and potential influencers for the feedback based on, for example, one or more system logged events.

### BACKGROUND

Conventional techniques for identifying influencers of user feedback have evolved away from mere pen-and-paper implementations as the complexity increases have increasingly relied on technological solutions. With the advent of computing devices, receiving user feedback electronically has enabled content providers on the Internet to aggregate massive amounts of data representing feedback in real-time from customers to identify ways to improve their products and services.

For example, some conventional approaches may simply identify whether user feedback is positive or negative. An Internet user may provide feedback on web page for a content provider's website, for example. Using semantic analysis engines, administrators of the content provider's website may determine, algorithmically, whether the feedback provided was positive or negative. Despite the ease of using semantic analysis engines, conventional systems are not well-suited to identifying the sources of the feedback without expending resources or requiring manual intervention.

While conventional approaches are functional, the usual structures and/or functionalities for identifying influencers of user feedback are not suited to the increasing technological demands required to optimally respond to the feedback.

Thus, what is needed is a solution for effectively identifying causes of user feedback without the limitations of conventional techniques.

### BRIEF DESCRIPTION OF THE DRAWINGS

Various embodiments or examples (“examples”) of the invention are disclosed in the following detailed description and the accompanying drawings:

FIG. 1A is a high-level block diagram depicting a process of receiving user feedback in a listing management system, according to an embodiment;

FIG. 1B is a high-level block diagram depicting a process of detecting events based on user feedback in a listing management system, according to an embodiment;

FIG. 2A is a network diagram of a system for detecting events based on user feedback in a listing management system, showing a block diagram of the listing management system, according to an embodiment;

FIG. 2B is a high-level block diagram of a system for detecting events based on user feedback in a listing management system, according to an embodiment;

FIGS. 3A-F are example screenshots of a process for detecting events based on user feedback, according to an embodiment;

FIG. 4 is a flow chart of a process for providing detected events based on user feedback for display, according to some examples;

FIG. 5 is a flow chart of a process for detecting events based on user feedback, according to some examples;

FIG. 6 illustrates an exemplary computing platform disposed in a device configured to detect events based on user feedback on implementation of an event detector in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

Traveling around the world has never been easier in the Internet age. People wishing to travel cheaply, with family, or luxuriously may search various websites for the best deals and/or best amenities for hotels, vacation homes, and short-term rentals. With the advent of on-demand housing software applications, owners and travelers may interact with property listings on various websites, mobile applications, and application services. For example, a homeowner may list their property on an on-demand housing software application with an availability, rental cost, description of the property, and photos with accompanying captions describing the property. Travelers may browse through the various property listings, bookmark or indicate interest in a particular listing, and submit reviews for property listings via the on-demand housing software application provided through a mobile application operating on a mobile device or a website running on a web browser accessed through the Internet.

Users may also provide feedback to administrators of the on-demand housing software application through various methods, such as leaving a comment on a webpage, clicking a positive or negative button, or even posting content on third-party websites about the on-demand housing software application. The on-demand housing software application may further capture information about users' experience, such as browser events, like clicks, page loads, page refreshes, as well as mobile application metrics and so forth.

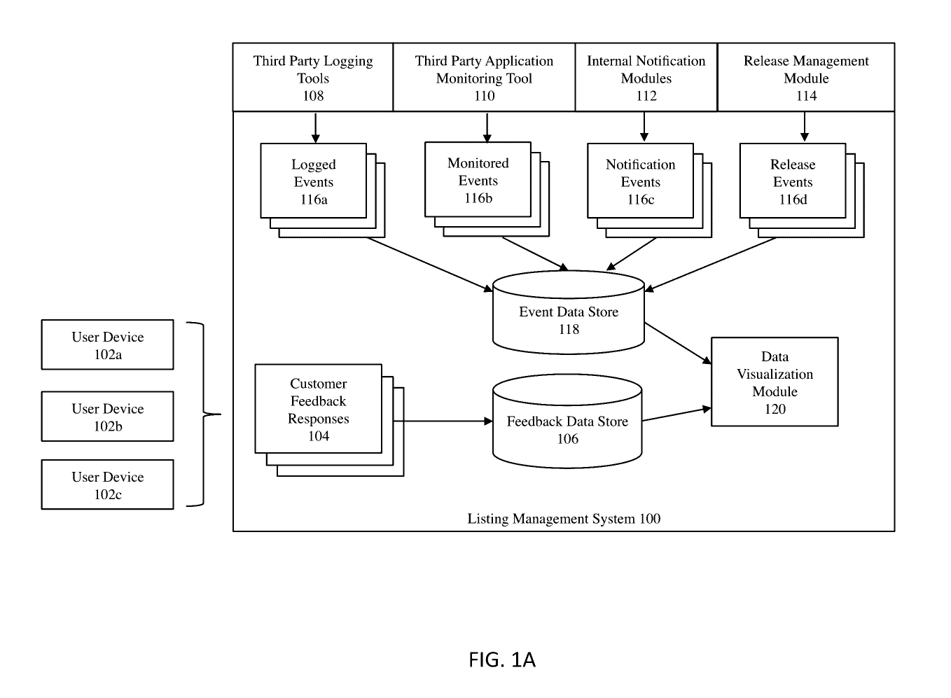

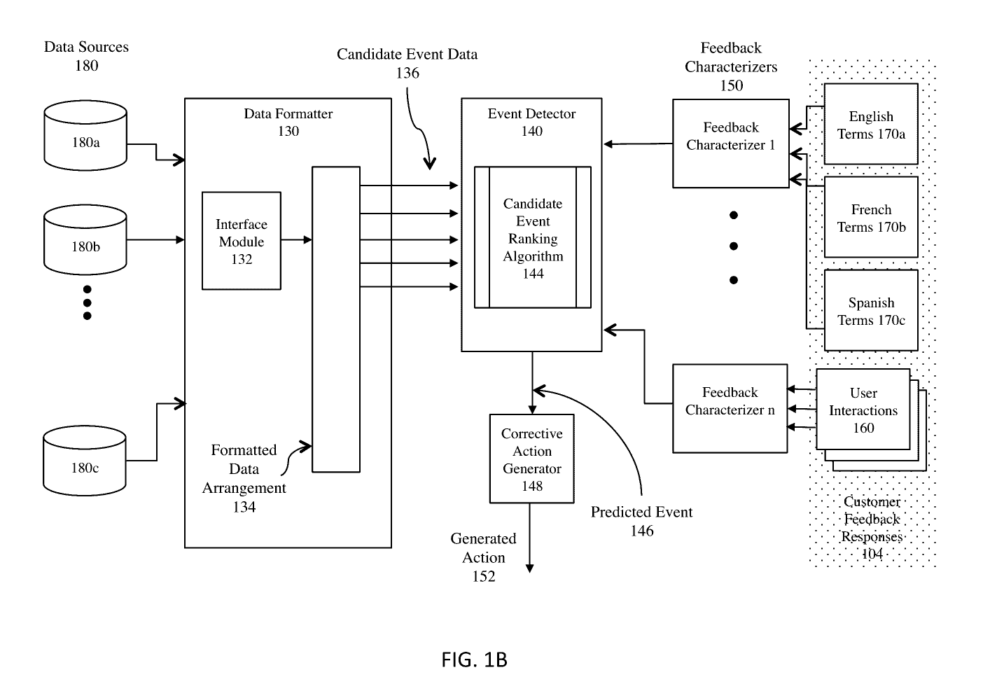

FIG. 1A is a high-level block diagram depicting a listing management system 100, according to some embodiments. The listing management system 100 may receive customer feedback responses 104 from user devices 102 (e.g., user devices 102a, 102b, and 102c) that are stored in a feedback data store 106. Administrators may access the listing management system 100 through a user device 102 through a separate login process, in one embodiment.

FIG. 1A and the other figures use like reference numerals to identify like elements. A letter after a reference numeral, such as “102a,” indicates that the text refers specifically to the element having that particular reference numeral. A reference numeral in the text without a following letter, such as “102,” refers to any or all of the elements in the figures bearing that reference numeral (e.g., “102” in the text refers to reference numerals “102a,” “102b,” and/or “102c” in the figures). Only three user devices 102 are illustrated in FIG. 1A in order to simplify and clarify the description.

As mentioned above, customer feedback responses 104 may include various types of data sources, from a user's clicks on a web browser to refresh a widget that may be malfunctioning to a user review of a property listing, noting that the hot tub didn't work well. Customer feedback responses 104 are received from the user devices 102 to the listing management system 100 and stored into the feedback data store 106. As shown in FIG. 1B, customer feedback responses 104 may be characterized as either positive or negative, in one embodiment, through various feedback characterizers 150.

Referring again to FIG. 1A, many types of events 116 may be received about the listing management system 100 from various sources. For example, logged events 116a may be received from one or more third party logging tools 108, such as SPLUNK. Logged events 116a may be recorded in a log file that captures every event that occurs on the listing management system 100, in one embodiment. Monitored events 116b may be received from a third party application monitoring tool 110, such as NEW RELIC. The third party application monitoring tool 110 may be integrated into the listing management system 100 and may generate various monitored events 116b that provide information about network and application performance, application code diagnostics, server health issues, mobile infrastructure performance management, code level visibility, browser page load times, throughput, transactions, JavaScript errors, AJAX timing issues, as well as plugin monitoring.

Notification events 116c may be received from one or more internal notification modules 112. For example, an internally developed tool may track a number of database calls by a server to a property listings data store as well as other database metrics. A notification event 116c may be generated if the data store is locked or otherwise generating errors. The notification event 116c may provide one or more information items that provide useful information that caused errors for internal systems in the listing management system 100.

Release events 116d may be received from a release management module 114. Release events 116d may indicate that one or more portions of the listing management system 100 may have been upgraded or otherwise modified in a software release. Information in a release event 116d may include an identifier of one or more systems affected by the release, information about what was changed, and so forth.

Events 116 may be stored in an event data store 118. In one embodiment, the event data store 118 may store a portion or all of the disparate event types, logged events 116a, monitored events 116b, notification events 116c, and release events 116d. In another embodiment, events 116 may be stored as separate data stores. Referring now back to FIG. 1B, data sources 180 illustrate one or more data stores in which events 116 may be stored.

Each event type may include a separate adapter to format the disparate event data types into a cohesive data arrangement, according to at least some examples. A data formatter 130 may include an interface module 132 that includes one or more adapters for the event data received from data sources 180. The data formatter 130 may generate a formatted data arrangement 134 for a period of time upon receiving an instruction to generate such a data structure, in one embodiment. As an example, if a web server starts to fail, a third party application monitoring tool may generate one or more monitored events 116b that are stored in a data source 180a. At the same time, an internal notification module 112 may generate one or more notification events 116c stored in a data source 180b. Further, a third party logging tool 108 may log several errors that have been received when attempting to use the failed web server. These errors may be included in a log file, where each error is a logged event 116a stored in a data source 180c. The data formatter 130 may include rules such that an error or a failed web server automatically triggers the generation of a formatted data arrangement 134 for the disparate data sources 180 recording, asynchronously, diagnostic data captured by various systems integrated into the listing management system 100.

The formatted data arrangement 134 may include one or more status flags of various systems in the listing management system 100, in one embodiment. For example, each widget and user interface element provided by the listing management system 100, such as a calendar to book listings, a photo viewer to view pictures of the properties, and a search and filter tool to narrow the listings based on budget, amenities, and so forth, may be identified as a user facing component of the listing management system 100 which may be affected by one or more internal and external systems. In one embodiment, a status flag may indicate whether that component is working within normal parameters or whether the component is defective in one or more ways.

Status flags may differ by component in the listing management system. For example, when a web server goes down, the status flag may be “offline” or “0” as a way to quickly identify a health of the component. If a web server is experiencing a heavy load such that requests take awhile to process, the status flag may be “delayed” or a number between 0 and 1, in one embodiment. If the web server is operating within normal parameters, the status flag may be “online” or “1”, in an embodiment. However, a status flag for a calendar widget may either be “0” or “1” based on whether it is operational. Status flags may also be more detailed and granular based on the event type. For example, a release event 116d may indicate that a new user-facing feature is being released for the listing management system 100. The new feature may trigger creation of a new component as recognized by the data formatter 130. As such, the status flag of that component may indicate the various stages of creation, such as “null,” “in process,” “awaiting review,” and “complete,” for example. A formatted data arrangement 134 may be a data structure, a data process, or a data module in the listing management module 100, in one embodiment. Formatted data arrangement 134 may further enhance operability of computational resources, such as servers, processors, data storage devices, etc., for performing the various functionalities described herein.

An event detector 140 may receive candidate event data 136 from a data formatter 130, and in particularly from the formatted data arrangement 134. The event detector 140 may also receive data from one or more feedback characterizers 150. Feedback characterizers 150 may be used to characterize customer feedback responses 104. For example, users of the listing management system 100 may provide reviews of listings in various languages, including English, French, and Spanish. In one embodiment, terms 170 may be identified by a feedback characterizer 150 that indicates a sentiment of a review. Certain English terms 170a, French terms 170b, and Spanish terms 170c may be identified as having positive, negative, or neutral connotations. In another embodiment, specific terms 170 may be identified as being related to the on-demand housing software application provided by the listing management module 100, such as “calendar,” “website,” “app,” and “page,” while other terms 170 may be related to properties or amenities provided owners in the listings presented, such as “bathroom,” “pool,” “bed,” and so forth.

In one embodiment, the event detector 140 receives a portion of a formatted data arrangement 134 based on the one or more data items received from the feedback characterizers 150. In that embodiment, the event detector 140 may determine that only a portion of the formatted data arrangement 134 is needed to determine one or more events 116 that may qualify as candidate events 136. According to some examples, event detector 140 may be configured to correlate a subset of candidate event data to a subset of characterized feedback to predict an event that likely is an influencer of the feedback. A candidate event ranking algorithm 144 in the event detector 140 may rank the candidate events 136 based on the received characterized feedback data to determine a predicted event 146. For example, returning to the failed web server example above, feedback characterizers 150 may provide data indicating users clicking on links multiple times, browsers refreshing pages at an abnormally high rate (e.g., over a predetermined threshold), applications delivered on mobile devices receiving poor ratings, and a spike (e.g., over a threshold) of negative comments on reviews associated with listings (e.g., “web site is slow”) in the listing management system 100. This data may be identified for a particular period of time. The candidate event ranking algorithm 144 may request candidate event data 136 from the formatted data arrangement 134 for that period of time based on the received feedback characterization data. As a result, the candidate event ranking algorithm 144 may generate one or more possible candidate events that may explain why such negative feedback was received during that period of time. Here, the most likely candidate may be the web server failing, as that event may cause large disturbances in the functioning of the listing management system 100. The predicted event 146 may be selected by the event detector 140 to be delivered to a corrective action generator 148.

The corrective action generator 148 may receive one or more predicted events 146 and take corrective action within the listing management system 100 automatically based on one or more preconditions being met. In some embodiments, actions to correct identified problems may have already been taken by administrators of a listing management system 100 and the only corrective action to be taken is to generate a customer service message to users affected by the predicted event 146. In other embodiments, one or more corrective actions 152 may be generated to address the predicted events 146 received by the event detector 140. Continuing the example above, if a web server fails and has been identified as the predicted event 146 causing negative feedback, a new web server clone may be instantiated and brought online, assuming web server onboarding automation has been enabled by the listing management system 100, in one embodiment. In another embodiment, a web server request message may be sent to one or more infrastructure teams supporting the listing management system 100. In a further embodiment, one or more customer service messages may be delivered to users of the listing management system 100 requesting patience while the web server is being repaired. As a result, customers may feel that their voice has been heard and may be more likely to remain users of the listing management system 100. Further, this customer service messaging may be automated and handled in multiple languages across the world, requiring no manual intervention on the part of administrators of the listing management system 100. In the past, an event such as a web server failing may cause users to lose confidence in the content provider, but this automated event detection system enables the listing management system to respond faster to received negative feedback and automatically generate one or more corrective actions 152.

Returning to FIG. 1A, data from the event data store 118, such as formatted data arrangement 134 and the feedback data store 106, in one embodiment, may be sent to a data visualization module 120. The data visualization module 120 may provide one or more user interfaces for administrators to parse through various event data 116 and feedback responses 104 quickly and efficiently. By parsing through the various event data types, an administrator may select, in one embodiment, a predicted event 146 for a corrective action generator 148 to automatically take action within the listing management system 100. For example, the event detector 140 may require that an administrator select from the top three generated predicted events 146 in order to take corrective action. This may be required because sending hundreds of thousands of email messages apologizing for a failed web server, for example, may or may not be needed depending on whether the failed web server actually caused the negative feedback. An administrator may, through the data visualization module 120, interact with various user interfaces with the top 3 predicted events 146 visualized against the customer feedback responses 104 and select the predicted event 146 to automatically create a generated action 152, in one embodiment.

### System Architecture

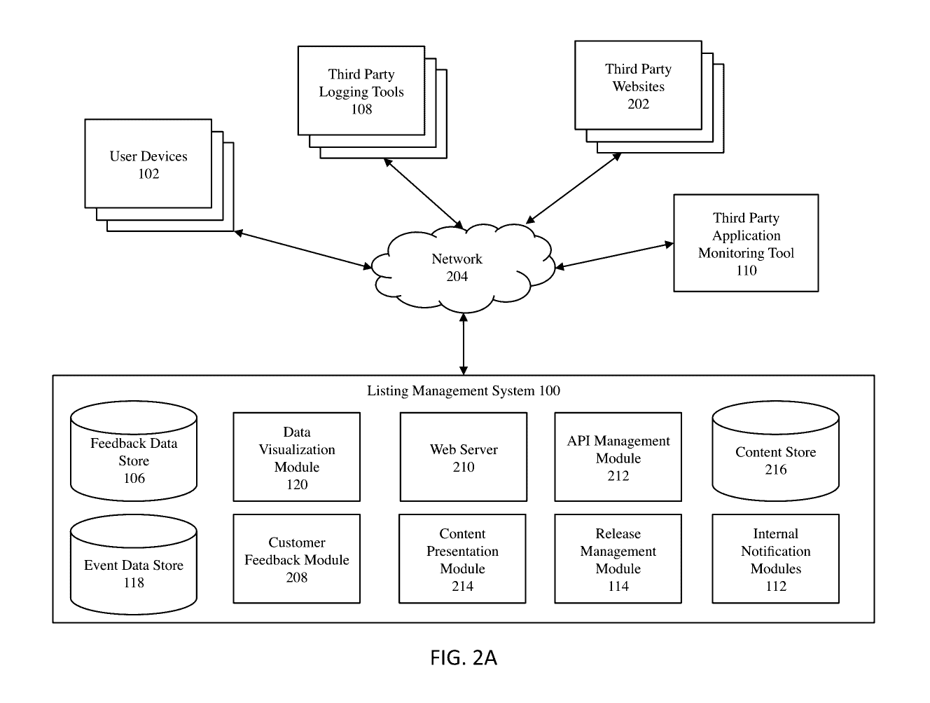

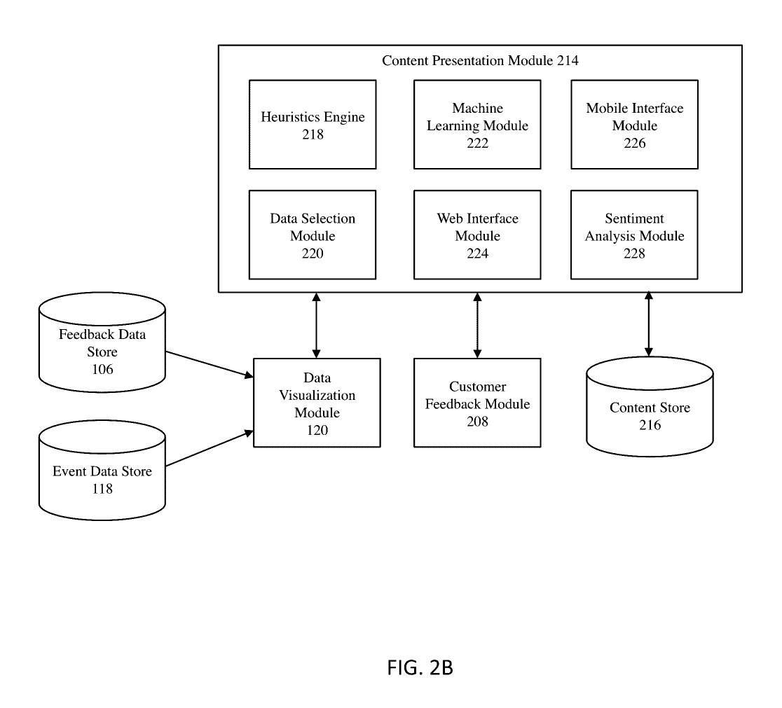

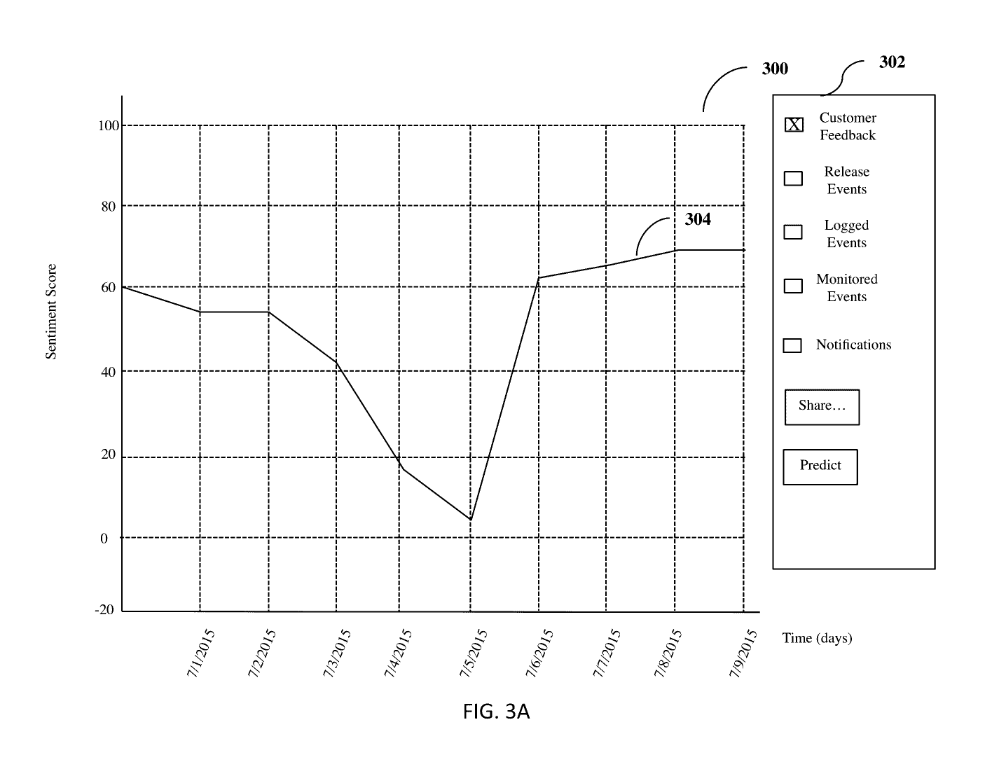

FIG. 2A is a network diagram of a system for detecting events based on user feedback in a listing management system, showing a block diagram of the listing management system, according to an embodiment. The system environment includes one or more user devices 102, third party logging tools 108, third-party websites 202, a third party application monitoring tool 110, the listing management system 100, and a network 204. In alternative configurations, different and/or additional modules can be included in the system.

The user devices 102 may include one or more computing devices that can receive user input and can transmit and receive data via the network 204. In one embodiment, the user device 102 is a conventional computer system executing, for example, a Microsoft Windows-compatible operating system (OS), Apple OS X, and/or a Linux distribution. In another embodiment, the user device 102 can be a device having computer functionality, such as a personal digital assistant (PDA), mobile telephone, smart-phone, wearable device, etc. The user device 102 is configured to communicate via network 204. The user device 102 can execute an application, for example, a browser application that allows a user of the user device 102 to interact with the listing management system 100. In another embodiment, the user device 102 interacts with the listing management system 100 through an application programming interface (API) that runs on the native operating system of the user device 102, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2A contains a block diagram of the listing management 100. The listing management system 100 includes a feedback data store 106, an event data store 118, a data visualization module 120, one or more internal notification module 112, a release management module 114, a web server 210, a content store 216, a customer feedback module 208, an API management module 212, and a content presentation module 214. In other embodiments, the listing management system 100 may include additional, fewer, or different modules for various applications. Conventional components such as network interfaces, security functions, load balancers, failover servers, management and network operations consoles, and the like are not shown so as to not obscure the details of the system.

The web server 210 links the listing management system 100 via the network 204 to one or more user devices 102; the web server 210 serves web pages, as well as other web-related content, such as Java, Flash, XML, and so forth. The web server 210 may provide the functionality of receiving and routing messages between the listing management system 100 and the user devices 102, for example, instant messages, queued messages (e.g., email), text and SMS (short message service) messages, or messages sent using any other suitable messaging technique. The user can send a request to the web server 210 to upload information, for example, images or videos that are stored in the content store 216. Additionally, the web server 210 may provide API functionality to send data directly to native user device operating systems, such as iOS, ANDROID, webOS, and RIM.

A content store 216 may store content uploaded by users of the listing management system 100. Content for a property listing may include text describing the property listing, photos and/or video of the property, reviews provided by travelers staying at the property listing, amenities available at the property, contact information of the owner or property manager, and so forth. Content for a traveler may include profile information about the traveler, in one embodiment. Content for users may be retrieved from third party websites 202, in one embodiment, such as a social networking system like TWITTER or FACEBOOK. The content store 216 may store this content for use in the listing management system 100.

A customer feedback module 208 may receive feedback data from users of the listing management system 100. In one embodiment, the customer feedback module 208 may identify one or more abnormal browser events, such as multiple page loads, page refreshes, clicking on various links provided on a web page, and so forth. In another embodiment, the customer feedback module 208 receives review data and other comments from users of the listing management system 100. In yet another embodiment, the customer feedback module 208 may manage one or more social media accounts for the listing management system 100 operated on third party websites 202, such as TWITTER and FACEBOOK to receive comments and reviews from users of the listing management system 100. In one embodiment, the customer feedback module 208 may utilize one or more third party tools 110 to parse text received from users of the listing management system 100.

An API management module 212 may manage one or more adapters needed for the listing management system 100 to communicate with third party logging tools 108, third party websites 202, and a third party application monitoring tool 110. Application programming interfaces (APIs), or adapters, may be used to push data to the external tools, websites, and user devices 102. Adapters may also be used to receive data from the external systems. In one embodiment, the API management module 212 manages the amount of connections to the external systems needed to operate efficiently.

A content presentation module 214 is further illustrated in FIG. 2B. FIG. 2B illustrates a high-level block diagram of a system for providing detected influencer events based on user feedback in a listing management system, according to an embodiment. FIG. 2B includes the content presentation module 214 which includes a heuristics engine 218, a data selection module 220, a machine learning module 222, a web interface module 224, a mobile interface module 226, and a sentiment analysis module. The content presentation module 214 may provide content on a listing management system 100, including photos, videos, text, and graphics. In an embodiment, the content presentation module 214 may provide one or more graphical representations of customer feedback in conjunction with received event data, as transformed by a data visualization module 120. In a further embodiment, a content presentation module 214 may operate in conjunction with the event detector 140, the corrective action generator 148, feedback characterizers 150, and the data formatter 130, as illustrated in FIG. 1B, to detect influencer events based on received feedback data.

A heuristics engine 218 may include one or more heuristics rules to determine one or more outcomes. For example, the candidate event ranking algorithm 144 of the event detector 140 may use the heuristics engine 218 to determine a ranking of candidate events based on the received characterized feedback. Certain events may have various heuristic rules associated with them, such as software releases (identify systems that are affected by the software release, if one of the affected systems receive spikes in customer feedback, then the software release may be an influencing event), system component failures (web servers, API servers, modules supporting user interface elements, and so forth), property listing translations, merging property listings from various brands across websites, and criticism directed to properties in the listings themselves (generate notifications to owners). Various heuristic rules may be generated by administrators to handle predicted events to automatically generate corrective actions, as described above, in one embodiment. In another embodiment, heuristic rules may also use ranges of parameters for various logged events 116a, monitored events 116b, notification events 116c, and release events 116d. For example, 30 notifications that a web server has failed may be used in a heuristic rule to take corrective action immediately.

A data selection module 220 may provide a user interface for a user to select various types of data to be presented on a listing management system 100. For example, logged events 116a, monitored events 116b, notification events 116c, and release events 116d may be visualized as graphical representations of data by the data visualization module 120. The data selection module 220 may provide a user with a user interface to filter through the different events 116 for a period of time.

A machine learning module 222 may use various machine learning methods, such as supervised and unsupervised learning methods, Bayesian knowledge base, Bayesian network, nearest neighbor, random walk, and other methods to determine various outcomes based on received event data and received characterized feedback. For example, if an administrator is presented with the top three predicted events, as described above in a previous example, and selects a certain predicted event 80% of the time, the machine learning module 222 may be used to further automate the process and create a heuristic rule to automatically perform the selected predicted event without requiring administrator intervention.

A web interface module 224 provides content for display within web browsers. Content may be displayed using various methods, such as JavaScript, Node.js, AJAX, and other methods of providing data via browsers. The web interface module 224 may receive content via the customer feedback module 208, in one embodiment, and present the data on a graphical representation of data through the data visualization module 120. In one embodiment, the content delivered by the web interface module 224 may be stored and retrieved from the content store 216.

Similarly, a mobile interface module 226 may provide content via an application natively operating on mobile devices, such as wearable devices and mobile phones. Mobile devices may require APIs to receive data from the listing management system 100. The mobile interface module 226 may present data for display through these APIs. In an embodiment, the mobile interface module 226 may receive content via the customer feedback module 208, in one embodiment, and present the data on a graphical representation of data through the data visualization module 120. In one embodiment, the content delivered by the mobile interface module 226 may be stored and retrieved from the content store 216.

A sentiment analysis module 228 may provide analysis of various text received by the listing management system 100 to determine whether the text exhibits positive or negative feedback. For example, a list of terms 170 may be used, in multiple languages, to determine whether text may be determined to be good or bad. The sentiment analysis module 228 may, in one embodiment, use various third party tools to perform this analysis. In another embodiment, the sentiment analysis module 228 may differentiate between negative feedback directed at a property (e.g., “the pool stinks”) and negative feedback directed at the website or mobile application supported by the listing management system 100 (e.g., “this app stinks” as feedback). Through the sentiment analysis module 228, the content presentation module 214 may provide an aggregated sentiment score that may provide an indicator of customer feedback in quantitative form for a period of time. This score may then be plotted in a graphical representation of the customer feedback, in one embodiment.

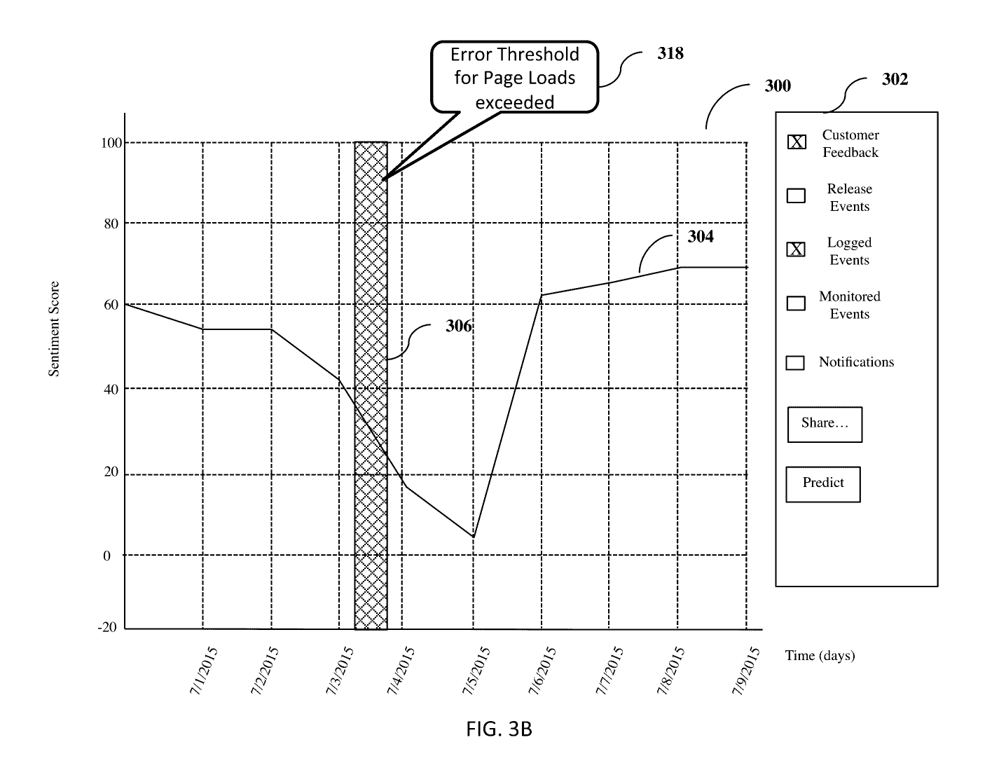

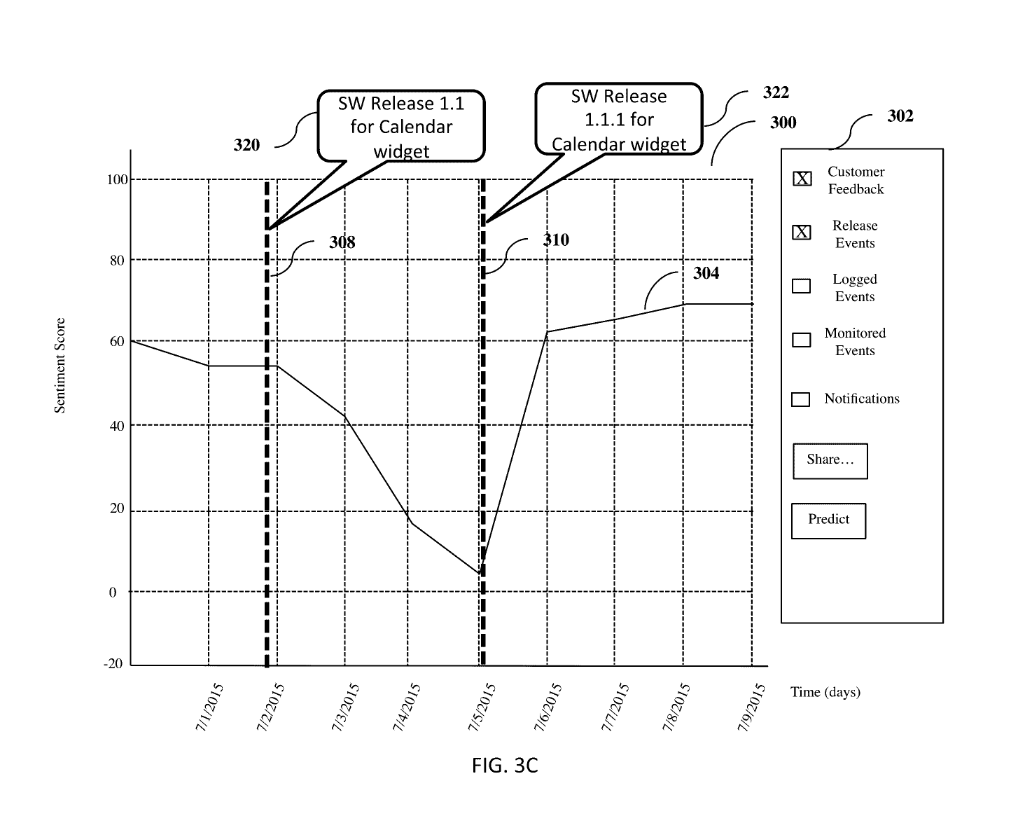

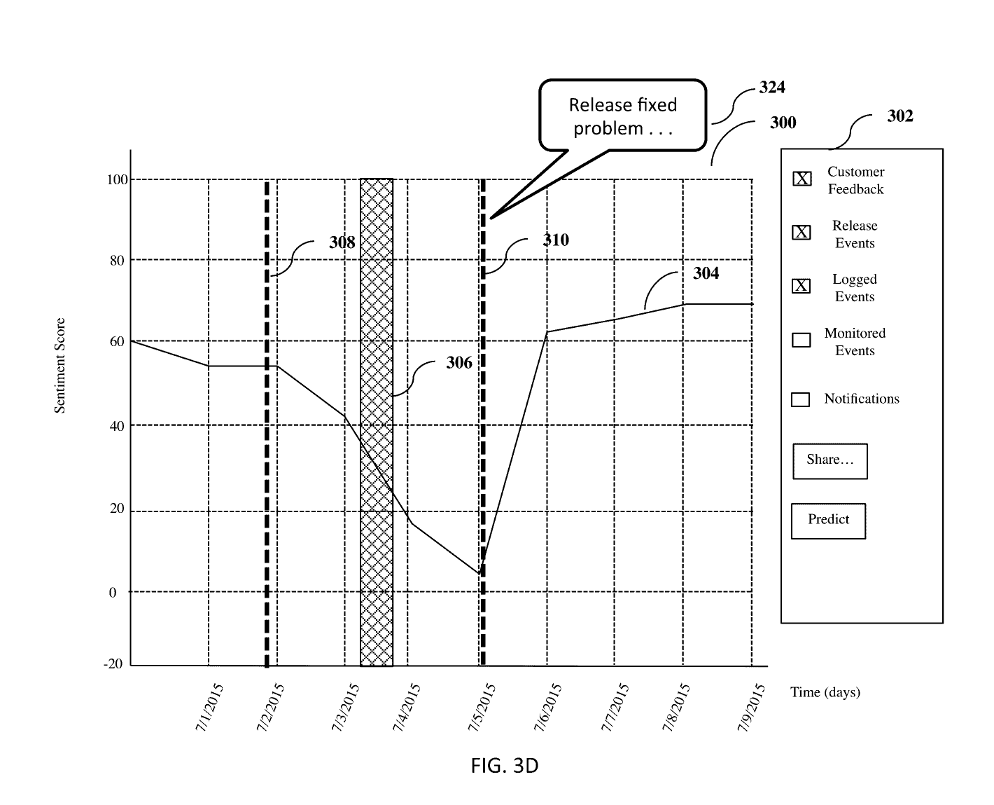

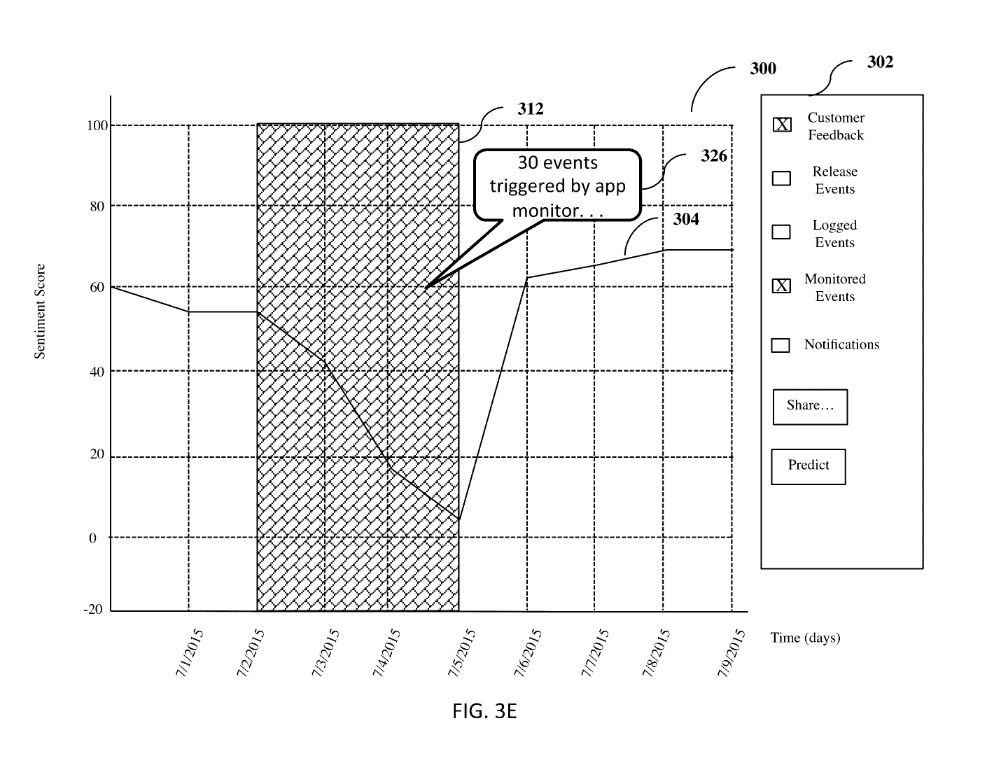

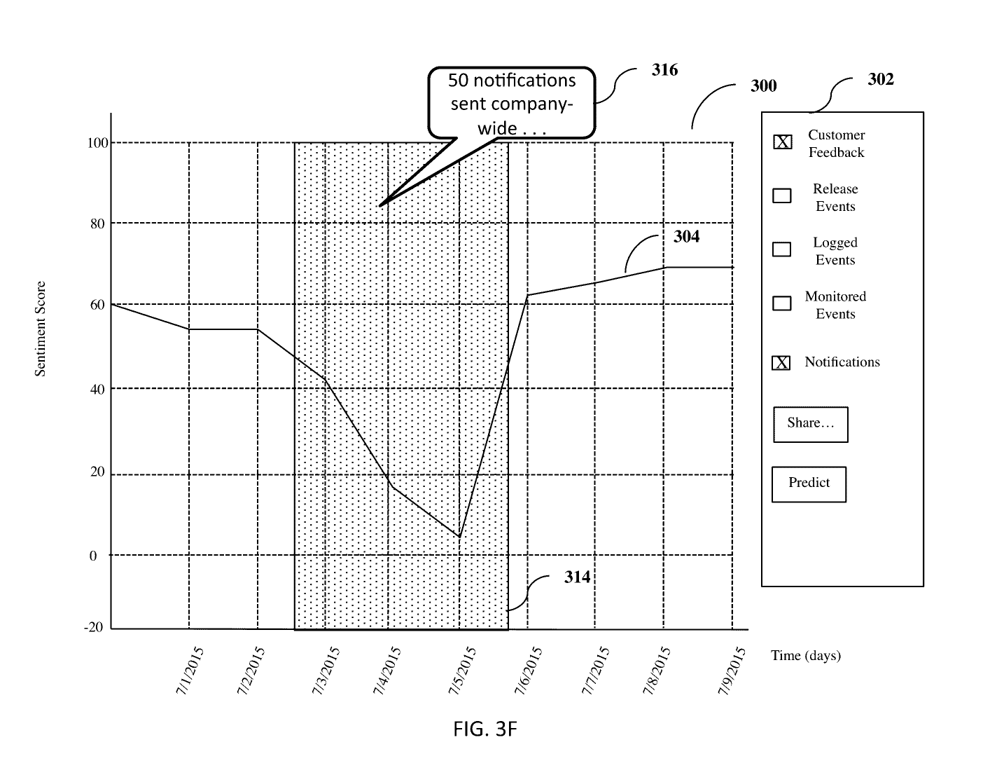

FIGS. 3A-F are example screenshots of a process for detecting influencer events based on user feedback, according to an embodiment. FIG. 3A illustrates a graphical user interface (GUI) 300 that includes a filter 302. A data plot 304 represents a sentiment score of users of a listing management system 100 over a period of time, from Jul. 1, 2015 to Jul. 9, 2015. The sentiment score is plotted on the GUI 300 from −20 to 100, with the data plot 304 ranging from 5 to 69, in one embodiment. As shown in FIG. 3A, the filter 302 has a check box selected for customer feedback and the data plot 304 illustrates the data for customer feedback as represented by a sentiment score.

FIG. 3B illustrates the GUI 300 after a logged events selection box has been checked in the filter 302. A shaded area 306 representing the logged events received during the time period displayed in the GUI appears on the GUI. In various embodiments, the shaded area may displayed as various shapes, colors, figures, forms, and other visual representations, but for purposes of simplicity, an X pattern has been used in the shaded area 306 to represent the logged events. A dialog box 318 displays information about the logged events, indicating that an error threshold for page loads has been exceeded. In one embodiment, the GUI 300 may include selectable links such that the various GUI elements, including the data plot 304 and the shaded area 306 may be selectable by the user viewing the GUI 300. Selecting user interface elements may cause one or more actions to be performed, such as viewing data in tabular format, viewing data in other graphical formats, or performing other actions in the listing management system 100.

FIG. 3C illustrates the GUI 300 after a release events selection box has been checked in the filter 302. The filter 302 also only has the customer feedback selection box checked, such that the data plot 304 remains illustrated on the GUI 300. A first dashed line 308 is plotted to represent a software release 1.1 for a calendar widget and a second dashed line 310 is plotted to represent a software release 1.1.1 for the calendar widget. The dashed lines 308 and 310 are plotted on or about the day and time of their respective releases. Dialog boxes 320 and 322 display information about the release events.

FIG. 3D illustrates the GUI 300 after the customer feedback, release events, and logged events selection boxes are checked in the filter 302, such that the data plot 304, shaded area 306, and dashed lines 308 and 310 are illustrated on the GUI 300. In one embodiment, a dialog box 324 may pop up to identify a predicted event that influenced or caused the drop in sentiment score from around 10:00 pm on Jul. 1, 2015 to around 12:10 am on Jul. 5, 2015. In one embodiment, a viewing user of the GUI 300 may have selected a predict button in the filter 302. In another embodiment, the listing management system 100 may have learned, through machine learning, that software releases fix problems and may be preceded by negative trending sentiment scores followed by positive trending sentiment scores. As a result, the dialog box 324 may indicate that the release fixed the problem, pointing to the dashed line 310 representing the 1.1.1 software release for the calendar widget.

FIG. 3E illustrates the GUI 300 after the customer feedback and monitored events selection boxes have been checked in the filter 302, such that the data plot 304 and shaded area 312 appear in the GUI 300. Shaded area 312 indicates that from Jul. 2, 2015 to Jul. 5, 2015, thirty (30) events were triggered by the app monitor, as further illustrated by dialog box 326. Similar to FIGS. 3A-D, in one embodiment, the shaded area 312 may be selectable such that a table or pop up may be shown to illustrate more information about the 30 events triggered by the app monitor. In that embodiment, information received from the third party application monitoring tool 110 may be presented for display in the GUI 300.

Similarly, FIG. 3F illustrates the GUI 300 after the customer feedback and notifications selection boxes have been checked in the filter 302, such that the data plot 304 and shaded area 314 appear in the GUI 300. A dialog box 316 may indicate that fifty notifications were sent company wide. In one embodiment, the viewing user may wish to share a screenshot of the GUI 300. By selecting a share button on the filter 302, the viewing user may the screenshot with other users of the listing management module 100, such as administrators, marketers, customer service representatives, and company executives. In another embodiment, an administrator may share a screenshot with third party websites 202.

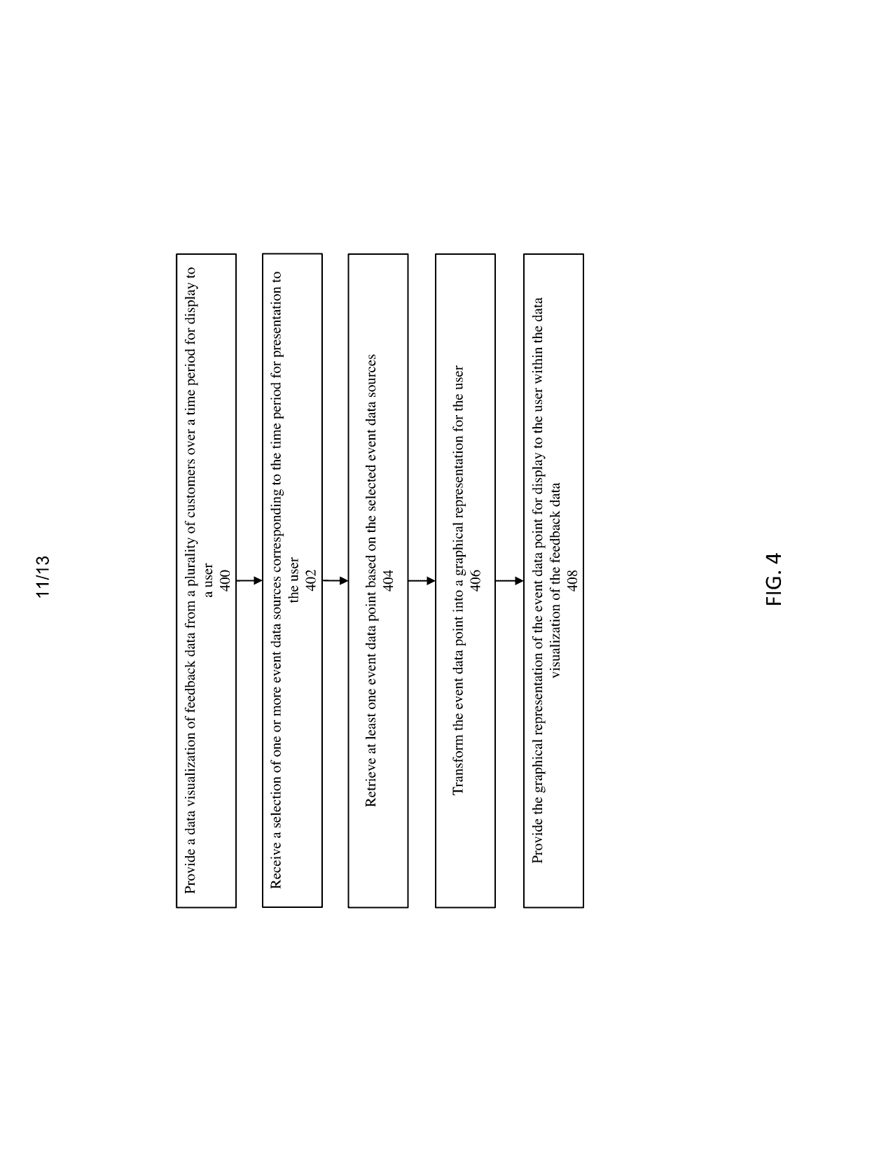

FIG. 4 is a flow chart of a process for providing detected events based on user feedback for display, according to some examples. A data visualization of feedback data from a plurality of customers over a time period is provided 400 for display to a user. This, in one embodiment, may include providing a graphical user interface for a user to select through various event data types received. A selection of one or more event data sources corresponding to the time period may be received 402 for presentation to the user. At least one event data point may be retrieved 404 based on the selected event data sources. The event data point may then be transformed 406 into a graphical representation for the user. Then, the graphical representation of the event data point may be provided 408 for display to the user within the data visualization of the feedback data.

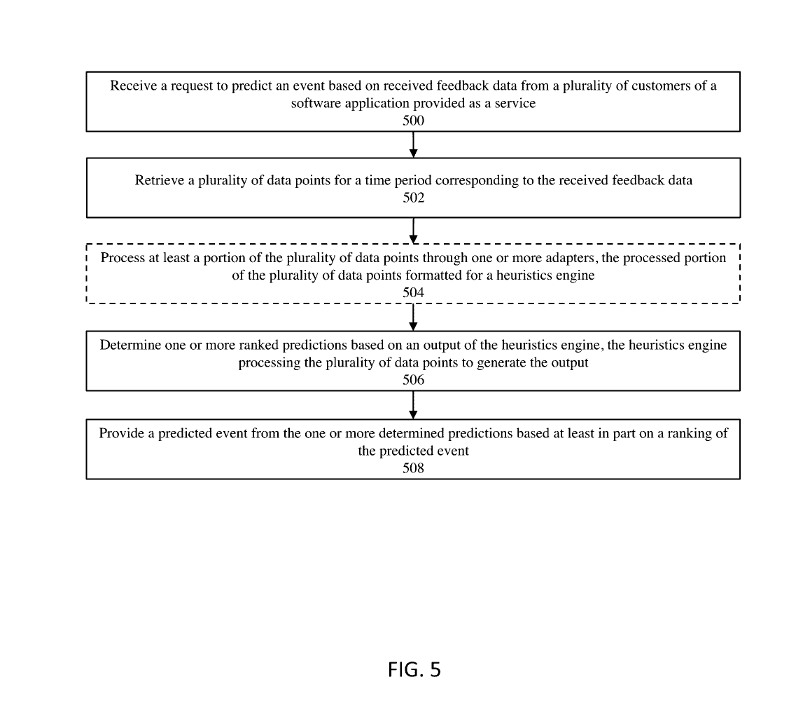

FIG. 5 is a flow chart of a process for detecting events based on user feedback, according to some examples. A request to predict an event based on received feedback data from a plurality of customers of a software application provided as a service is received 500. The request may be received 500 as a result of a selection of a user element in a GUI, as described above with respect to FIGS. 3A-F, such as a “predict” button in the filter 302. The request may also be received 500 has a result of machine learning algorithms detecting that certain preconditions have been met to merit requesting a prediction, in one embodiment.

A plurality of data points for a time period corresponding to the received feedback data may be retrieved 502. The data points may include characterized feedback data as retrieved from a formatted data arrangement 134, as described above. A portion of the formatted data arrangement 134 may be retrieved 502 as candidate event data 136. Optionally, at least a portion of the plurality of data points may be processed 504 through one or more adapters, the processed portion of the plurality of data points formatted for a heuristics engine.

One or more ranked predictions may be determined 506 based on an output of the heuristics engine, where the heuristics engine processed the plurality of data points to generate the output. As mentioned above, the event detector 140 may use the heuristics engine to determine 506 one or more ranked predicted events that influenced the received feedback data, in an embodiment. In another embodiment, the event detector 140 may determine the one or more ranked predictions using other methods, including machine learning methods and probabilistic methods as described above.

A predicted event may then be provided 508 from the one or more determined predictions based at least in part on a ranking of the predicted event. The predicted event may be provided 508 to one or more modules in the listing management system 100. In one embodiment, the predicted event may be provided 508 for display to the viewing user of a GUI 300. In another embodiment, the predicted event may be provided 508 to a corrective action generator 148, as described above, to automatically trigger an action that solves the problem identified by the predicted event.

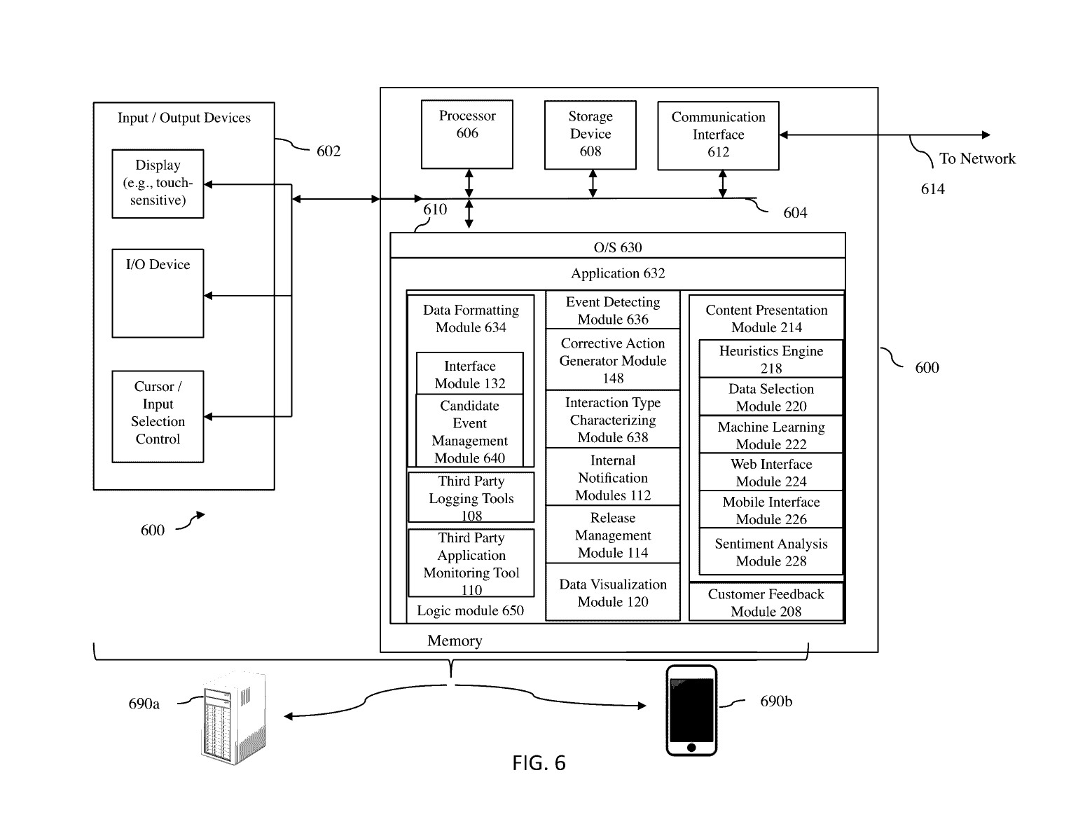

FIG. 6 illustrates an exemplary computing platform disposed in a device configured to detect influencer events based on feedback data in a listing management system 100 in accordance with various embodiments. In some examples, computing platform 600 may be used to implement computer programs, applications, methods, processes, algorithms, or other software to perform the above-described techniques.

In some cases, computing platform can be disposed in wearable device or implement, a mobile computing device 690b, or any other device, such as a computing device 690a.

Computing platform 600 includes a bus 604 or other communication mechanism for communicating information, which interconnects subsystems and devices, such as processor 606, system memory 610 (e.g., RAM, etc.), storage device 608 (e.g., ROM, etc.), a communication interface 612 (e.g., an Ethernet or wireless controller, a Bluetooth controller, etc.) to facilitate communications via a port on communication link 614 to communicate, for example, with a computing device, including mobile computing and/or communication devices with processors. Processor 606 can be implemented with one or more central processing units (“CPUs”), such as those manufactured by Intel® Corporation, or one or more virtual processors, as well as any combination of CPUs and virtual processors. Computing platform 600 exchanges data representing inputs and outputs via input-and-output devices 602, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 600 performs specific operations by processor 606 executing one or more sequences of one or more instructions stored in system memory 610, and computing platform 600 can be implemented in a client-server arrangement, peer-to-peer arrangement, or as any mobile computing device, including smart phones and the like. Such instructions or data may be read into system memory 610 from another computer readable medium, such as storage device 608. In some examples, hard-wired circuitry may be used in place of or in combination with software instructions for implementation. Instructions may be embedded in software or firmware. The term “computer readable medium” refers to any tangible medium that participates in providing instructions to processor 606 for execution. Such a medium may take many forms, including but not limited to, non-volatile media and volatile media. Non-volatile media includes, for example, optical or magnetic disks and the like. Volatile media includes dynamic memory, such as system memory 610.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 604 for transmitting a computer data signal.

In some examples, execution of the sequences of instructions may be performed by computing platform 600. According to some examples, computing platform 600 can be coupled by communication link 614 (e.g., a wired network, such as LAN, PSTN, or any wireless network, including WiFi of various standards and protocols, Blue Tooth®, Zig-Bee, etc.) to any other processor to perform the sequence of instructions in coordination with (or asynchronous to) one another. Computing platform 600 may transmit and receive messages, data, and instructions, including program code (e.g., application code) through communication link 614 and communication interface 612. Received program code may be executed by processor 606 as it is received, and/or stored in memory 610 or other non-volatile storage for later execution.

In the example shown, system memory 610 can include various modules that include executable instructions to implement functionalities described herein. System memory 610 may include an operating system (“O/S”) 630, as well as an application 632 and/or logic module 650. In the example shown, system memory 610 includes a data formatting module 634 including an interface module 132 and a candidate event management module 640. The system memory 610 may also include third party logging tools 108, a third party application monitoring tool 110, an event detecting module 636, a corrective action generator module 148, a feedback characterizing module 638, internal notification modules 112, a release management module 114, a data visualization module 120, a content presentation module 214 including a heuristics engine 218, a data selection module 220, a machine learning module 222, a web interface module 224, a mobile interface module 226, and a sentiment analysis module 228. The system memory 610 may further include a customer feedback module 208. One or more of the modules included in memory 610 can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a listing management system or one or more of its components, or any process or device described herein, can be in communication (e.g., wired or wirelessly) with a mobile device, such as a mobile phone or computing device, or can be disposed therein.

In some cases, a mobile device, or any networked computing device (not shown) in communication with an action alert controller or one or more of its components (or any process or device described herein), can provide at least some of the structures and/or functions of any of the features described herein. As depicted in the above-described figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, a content presentation module 214 or any of its one or more components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in the above-described figures can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit.

For example, a listing management system, including one or more components, or any process or device described herein, can be implemented in one or more computing devices that include one or more circuits. Thus, at least one of the elements in the above-described figures can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in anon-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A method comprising:
receiving a request to predict an event for received feedback data from a plurality of customer computing devices communicatively coupled, through a network, with a web service application;
interfacing a plurality of disparate data sources via a formatted data structure to acquire data points therefrom;
retrieving a plurality of data points via the formatted data structure for a time period corresponding to the received feedback data from the plurality of customers of the web service application to identify candidate events;
receiving subsets of data representing characterized feedback data;
determining one or more ranked predictions of the candidate events from the plurality of disparate data sources using a heuristics engine, the heuristics engine processing the plurality of data points for the time period and the received characterized feedback data to determine the one or more ranked predictions of the candidate events; and
providing a predicted event from the one or more ranked predictions responsive to the request based at least in part on a ranking of the predicted event.

2. The method of claim 1, wherein determining the one or more ranked predictions using the heuristics engine comprises:
correlating subsets of data points to the subset of data representing characterized feedback data; and
determining a subset of data points correlates to a type of the characterized feedback data to identify the candidate event.

3. The method of claim 2, wherein the subset of data points is determined to correlate to a type of characterized feedback data based on the subset of data points being within a threshold range of values.

4. The method of claim 2, wherein the subset of data points is determined to correlate to a type of characterized feedback data based on the subset of data points being within statistically relevant parameters.

5. The method of claim 2, further comprising:
categorizing the subset of data points as an anomaly; and
generating corrective action data to eliminate the anomaly.

6. The method of claim 5, wherein categorizing the subset of data points as an anomaly further comprises:
detecting a decrease in magnitude of the characterized feedback.

7. The method of claim 5, wherein categorizing the subset of data points as an anomaly further comprises:
detecting a decrease in negatively-connotated characterized feedback.

8. The method of claim 5, wherein categorizing the subset of data points as an anomaly further comprises:
detecting an increase in positively-connotated characterized feedback.

9. The method of claim 1, wherein determining the one or more ranked predictions using the heuristics engine further comprises:
retrieving one or more heuristic rules for predicting one or more reasons for the received feedback data;
applying the plurality of data points to the retrieved one or more heuristic rules; and
determining the one or more ranked predictions based on an outcome of the one or more heuristic rules.

10. The method of claim 1, wherein interfacing a plurality of disparate data sources further comprises using at least one application programming interface (API).

11. The method of claim 1, wherein the plurality of disparate data sources are interfaced from different applications external to the web service application.

12. The method of claim 1, wherein the plurality of disparate data sources are interfaced from different database external to the web service application.

13. A method comprising:
providing a visualization of feedback data from a plurality of customers over a time period for display to a viewing user in a graphical user interface comprising selectable event data sources;
receiving a selection of an event data source of the selectable event data sources;
retrieving at least one data point from the event data source; and
rendering a graphical representation of the at least one data point in the graphical user interface for display to the viewing user.

14. The method of claim 13, wherein retrieving the at least one data point from the event data source further comprises:
generating a request for event data within the time period; and
receiving the at least one data point responsive to the request.

15. The method of claim 13, wherein retrieving the at least one data point from the event data source further comprises:
generating a request for event data within the time period from the event data source;
formatting a response from the event data source based on the request; and
providing the formatted response as the at least one data point.

16. The method of claim 13, wherein rendering the graphical representation of the at least one data point in the graphical user interface for display to the viewing user further comprises:
generating an interactive user interface element based on the at least one data point for the time period; and
overlaying the interactive user interface element on the visualization of feedback data in the graphical user interface.

17. The method of claim 13, further comprising:
receiving a request from the viewing user to share the rendered graphical representation of the at least one data point in the graphical user interface, the request to share comprising sending a screenshot of the graphical user interface to a recipient; and
responsive to the request, transmitting the screenshot to the recipient.

18. The method of claim 13, further comprising:
receiving a request from the viewing user to display one or more predictions associated with the visualization of feedback data from the plurality of customers over the time period in the graphical user interface;
responsive to the request, retrieving a plurality of data points from available event data sources;
determining one or more ranked candidate events based on a heuristics engine processing the plurality of data points; and
providing the one or more ranked candidate events as the one or more predictions for display responsive to the request within the graphical user interface.

19. A system comprising:
a plurality of computing devices including:
a first server configured to download an application onto a user device, the application being configured to generate a request to predict an event for received feedback data from a plurality of customer computing devices communicatively coupled, through a network, with a web service application configured to operate on a second server; and
the second server comprising a computer readable medium and at least one processor including computer instructions that configure the processor to:
interface a plurality of disparate data sources via a formatted data structure to acquire data points therefrom;
retrieve a plurality of data points via the formatted data structure for a time period corresponding to the received feedback data from the plurality of customers of the web service application to identify candidate events;
receive subsets of data representing characterized feedback data;
determine one or more ranked predictions of the candidate events from the plurality of disparate data sources using a heuristics engine, the heuristics engine processing the plurality of data points for the time period and the received characterized feedback data to determine the one or more ranked predictions of the candidate events; and
provide a predicted event from the one or more ranked predictions responsive to the request based at least in part on a ranking of the predicted event to the user device.

20. The system of claim 19, further comprising:
an administrator user device configured to operate the application and further configured to generate the request.
